(19) United States
(12) Patent Application Publication
(10) Pub. No.: US 2009/0216562 A1
(43) Pub. Date: Aug. 27, 2009

(54) METHOD AND APPARATUS FOR ACCOMMODATING DIVERSE HEALTHCARE RECORD CENTERS

(76) Inventors: Judith R. Faulkner, Madison, WI (US); Carl D. Dvorak, Verona, WI (US); Brian M. Weisberger, Madison, WI (US); Janet L. Campbell, Madison, WI (US); Timothy W. Escher, Lodi, WI (US); Dustin L. Gage, Madison, WI (US); Sean Conrad, Madison, WI (US); Bhavik Shah, Madison, WI (US); Michael J. Kantor, Madison, WI (US); Matthew D. Sidney, Fitchburg, WI (US)

Correspondence Address: BOYLE FREDRICKSON S.C., 840 North Plankinton Avenue, MILWAUKEE, WI, 53203, US

(21) Appl. No.: 12/391,130

(22) Filed: Feb. 23, 2009

Related U.S. Application Data
(60) Provisional application No. 61/030,725, filed on Feb. 22, 2008.

(51) Int. Cl. G06Q 50/00; G06F 3/048; G06F 17/30

(52) U.S. Cl. 705/3; 705/2; 715/742; 707/9; 715/205

(57) ABSTRACT

A healthcare portal aggregator collects data from healthcare portals of different institutions to provide patients with a comprehensive view of their healthcare information. The aggregator visually organizes data by datatypes for easy reference while visually linking the data to healthcare institution identifiers to preserve the healthcare institution's connections to their patients.

### CROSS-REFERENCE TO RELATED APPLICATIONS

This application claims the benefit of U.S. provisional application 61/030,725 filed Feb. 22, 2008 hereby incorporated by reference.

### STATEMENT REGARDING FEDERALLY SPONSORED RESEARCH OR DEVELOPMENT

--

### BACKGROUND OF THE INVENTION

The present invention relates to electronic medical records and, in particular, to a system managing the transition from paper records to electronic medical records.

There is considerable interest in increasing the involvement of patients with their health care to promote better health care outcomes. Part of this effort has focused on providing patients with improved access to their healthcare records. In this regard, many healthcare providers have generated electronic portals using the Internet to provide patients with access to portions of their clinical medical record. These portals may also allow electronic communication of messages between a healthcare provider and the patient as well as the scheduling of appointments by the patient. As used herein, clinical medical data refers to medical information based on direct observation of patients by healthcare professionals.

An equally important development is third-party “personal health record” (PHR) websites which allow a patient to record patient-sourced health data. Such websites may further be configured to provide general health-related information. A patient may use a PHR site, for example, to keep a healthcare diary, record medications, track information such as weight or blood pressure, etc. These personal health record (PHR) sites serve a valuable purpose in preserving patient-sourced data and in providing continuity to a patient's medical information when healthcare providers are changed or multiple healthcare providers are used.

This fragmented nature of medical record-keeping can make it difficult for a patient or even the patient's physician to obtain a comprehensive understanding of the patient's medical status. For this reason, there is some call to develop a standard, electronic medical record format describing how medical records are stored and organized, possibly with the end goal of providing for each patient a single shared electronic medical record selectively accessible by different healthcare providers according to their need.

### BRIEF SUMMARY OF THE INVENTION

The present inventors believe that the diverse recordkeeping responsibilities (e.g., recordkeeping by both patients and healthcare providers) currently characterizing the healthcare industry may have inherent advantages in facilitating innovation and in preserving an incentive structure for accurate and complete recordkeeping. Accordingly, the present invention provides a method of integrating separately maintained health record systems while preserving the identity of the associated institutions as the data is merged. In this way, a consumer may have an integrated view of their health data without confusion as to the data source and the sourcing institutions can maintain their association with the data for branding purposes. The invention thereby provides many of the benefits of a centralized electronic medical record with minimum disruption to the marketplace.

Specifically then the present invention provides a health data portal aggregator having at least one electronic computer electronically connectable to a computer network communicating with at least two health data portals of the type providing access by a patient to clinical records of the patient from electronic medical record systems associated with corresponding healthcare institutions. The electronic computer executes a stored program to receive authentication information from a patient and use the authentication information together with stored access information for the health data portals to collect clinical records from the electronic medical record systems of the healthcare institutions. The clinical records may provide clinical medical data having datatypes and may display the clinical medical data visually aggregated by datatypes. Despite the aggregation, the aggregated clinical medical data remains visually associated with information identifying the healthcare institutions sourcing the clinical medical data.

Thus it is one feature of at least one embodiment of the invention to provide the patient with a system offering a global view of their health data in an environment where the incentives and structures for collecting medical data are distributed among various institutions. The present invention, by preserving institutional identity in the aggregation process, accommodates this diverse storage of medical data and preserves its branding value to the individual institutions.

The information identifying the healthcare institution may be a logo for the healthcare institution.

It is thus another feature of at least one embodiment of the invention to promote active participation by diverse institutions in aggregating data by preserving their association with the data.

The invention may further display hyperlinks to the health data portals in conjunction with the display of the clinical medical data. The information identifying the health care institutions may also be hyperlinks to the health data portals.

It is thus another feature of at least one embodiment of the invention to promote active participation by diverse institutions by preserving their association with the patient once diverted from their healthcare portal.

The electronic computer may further execute the stored program to receive patient-sourced data from the patient and to display the same to the patient.

It is thus another feature of at least one embodiment of the invention to allow the aggregator to also serve as a personal health record further aggregating the patient's records.

The patient-sourced data may include medical data and financial data related to medical treatment.

It is thus another feature of at least one embodiment of the invention to exploit the aggregation of data to assist in financial management of health costs.

The stored program may identify the datatypes of the health data by XML tags.

It is thus a feature of at least one embodiment of the invention to promote flexible coordination of medical information over the Web.

The stored program may review the collective clinical records for conflicts among records by looking for missing, duplicate, contradictory, and inconsistent data values. Alternatively or in addition, the stored program may review the collected clinical records to make recommendations to the patient.

It is thus a feature of at least one embodiment of the invention to leverage additional benefits from the aggregation of the patient's medical information by cross-checking that information for conflicts.

The stored program may further use the authentication information together with stored access programs for the health data portals to collect additional health information. Specifically, the program may collect health data information for multiple patients with whom the patient has established a data-access relationship, as established and governed by the electronic medical record system. The display of the clinical medical data may further identify the patient associated with each piece of clinical medical data.

It is thus a feature of at least one embodiment of the invention to allow families to aggregate medical information from multiple family members in a way that provides the benefits described above while distinguishing among the members.

Appointment data related to appointments at the corresponding healthcare institutions may also be collected and the appointment data visually aggregated by an appointment time and visually associated with information identifying the healthcare institutions related to the appointments.

Thus it is a feature of at least one embodiment of the invention to assist the user in coordinating appointments with multiple healthcare institutions.

These particular features and advantages may apply to only some embodiments falling within the claims and thus do not define the scope of the invention.

### BRIEF DESCRIPTION OF THE DRAWINGS

FIG. 1 is a graphical representation showing the operation of the present invention in aggregating health information from multiple healthcare providers and other record-keeping sources;

FIG. 2 is a figure similar to that of FIG. 1 showing the flow of data to different healthcare recordkeeping systems incident to a user login and the sorting of return data by a mapper according to the present invention;

FIG. 3 is a screen display of a webpage generated by the mapper of FIG. 2 such as preserves the identity of the individual healthcare record depositories;

FIG. 4 is a flow diagram showing one feature of the present invention for identifying inconsistencies among records held by different healthcare providers for an individual patient;

FIG. 5 is a diagram similar to FIG. 2 showing an implementation of proxy access among family members by the present invention;

FIG. 6 is a schematic representation depicting a linking of accounting software to the collected healthcare record per the present invention; and

FIG. 7 is a figure similar to that of FIG. 3 showing clinical data sorted by data type.

### DETAILED DESCRIPTION OF THE INVENTION

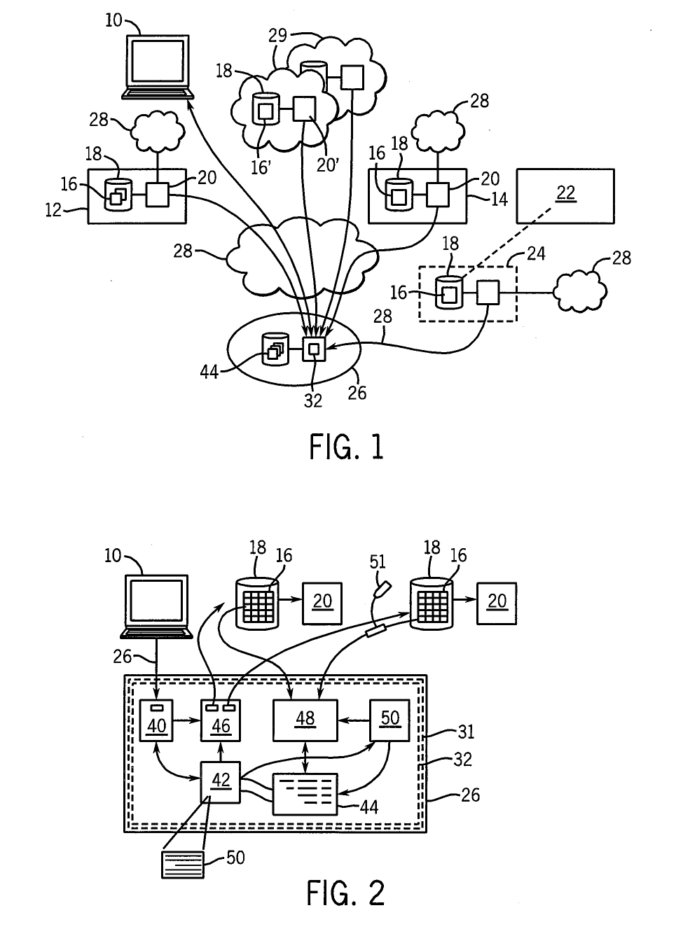

Referring now to FIG. 1, a patient may have a home terminal 10, such as a personal computer executing a browser program, connectable to one or more healthcare institutions or providers 12 and 14 via Web portals provided by those providers and providing a source of health data information. An example Web portal is the MyChart™ healthcare portal commercially available from Epic Systems Corporation of Verona, Wis.; however, other Web portal systems may also be used.

Each of the healthcare providers 12, 14 manages electronic medical records 16 related to the patient as held in a database 18 that may be accessed by a database management system 20. The database management system 20, in this example, includes or communicates with a Web server connected to the Internet to implement the Web portal.

The patient may also use one or more third-party “personal health records” (PHR) sites 29 containing non-clinical records 16′ as managed by a database management system 20′. These PHR sites 29 are simply websites that allow a patient to record patient-sourced health care information for storage. Examples of such third-party PHR sites 29 include WebMD (www.webmd.com), MyPHR (www.myphr.com), Microsoft's Healthvault (www.healthvault.com), and Google's Google Health.

In the past, the patient may have used a different healthcare provider 22 with whom they are no longer affiliated. In this regard, the patient may have archived the electronic medical records 16 held by this healthcare provider 22 in a database 18 of a medical record transport container 24 described in co-pending application filed on the same date as the present application entitled: “Method And Apparatus For Conserving Individual Medical Records” assigned to the assignee of the present invention and hereby incorporated by reference. This transport container 24 may provide for Web accessibility to the patient of the held electronic medical records 16.

In order to obtain a complete understanding of his or her healthcare status, a patient would normally have to communicate with each of these different record-keeping centers of: healthcare providers 12 and 14, third party PHR sites 29 and transport container 24. As will be described in more detail below, in the present invention the patient may communicate directly with an aggregator 26 via Internet connections 28. The aggregator may in turn communicate via Internet connections 28 with each of the database management systems 20 of the different healthcare data repositories to collect electronic medical records 16 and non-clinical records 16′ and to generate an overview record 34 which may be served to the patient by Internet connection 28 as a webpage or the like. The Internet connections 28 may also communicate other healthcare related data including messages to and from the healthcare providers, appointment scheduling information, and the like.

Referring now to FIG. 2, the aggregator 26 may execute a stored program 32 working through a Web server 31 to communicate with the home terminal 10 and to provide a login module 40 executing a security protocol with the patient during a patient login from the home terminal 10. Such a protocol may, for example, use a secure Web connection and request a password from the user to identify the particular patient with the necessary certainty.

Using this Web connection, the patient may enter data through the home terminal 10 per a data exchange module 42. On the first visit, the data exchange module 42 allows the patient to identify multiple healthcare providers 12 with whom the patient has Internet record access. In this regard, the patient is prompted to identify of these Web portals (by providing, for example, the URL, information leading to the URL, or other information identifying the portal) and the passwords 45, 45′ necessary to allow the data exchange module 42 to automatically connect to those Web portals and exchange data with them. This information is stored in a local file 50. The patient is also prompted to provide a password for the aggregator 26 that provide security for the information stored in the aggregator 26 and for the connections to the other record-keeping systems. This aggregator password allows a single password to obtain access to all healthcare information. This authentication credential is also stored as credentialing in the local file 50. After this setup process is complete, the patient may also use the data exchange module 42 to enter patient-sourced information directly to a local database 44, such information being of a type normally entered in a third-party PHR website.

Upon completion of the setup, for this visit and all subsequent visits, the program will execute a data collection module 46 which uses the password and URL information previously provided by the patient to contact each of the data repositories identified by the patient during the setup. These data repositories will include those of healthcare providers 12, 14, the transport container 24 and multiple third-party PHR sites 29.

Once a connection is established to each of these data repositories, the program 32 executes a mapper module 48 which collects information from each of these databases 18 either by downloading electronic medical records 16 and non-clinical records 16′ or by linking to the necessary electronic medical records 16 on demand. In this latter case, little or no actual patient record information need be stored in local database 44.

The mapper module 48 downloads information that identifies the type of information so as to be able to provide the patient with a logically arranged presentation of the patient's healthcare information. For common types of database management systems 20, this information may automatically be identified as to its context by the mapper module 48 using known reporting conventions or field identification tags 51 attached to data. These tags 51 may, for example, be XML tags proprietary to a given vendor, or part of an overarching standard. When data is downloaded from PHR sites 29, the mapper module 48 may be assisted by a local file 50 which contains mapping data provided by the patient through the data exchange module 42. This local file 50, for example, may contain a listing of potential categories of data and, together with the mapper module 48, may present to the user downloaded information allowing the user to select the appropriate category. The user may also identify dates or other information at this time when the data are not recorded or ambiguous. This may be most easily done by presenting the information to the patient in a window in a webpage and having a menu presenting a choice of categorizations and querying the patient when the date is required.

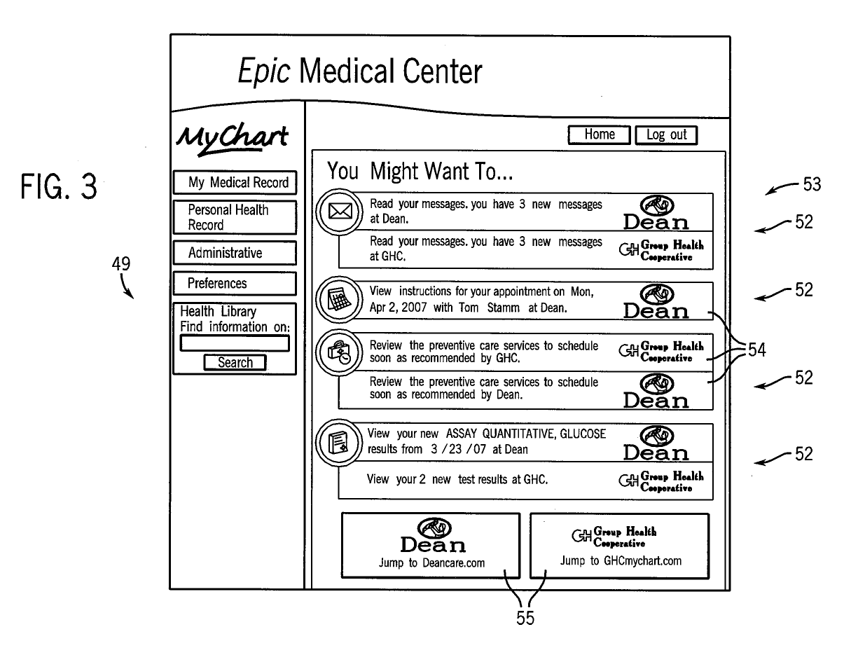

Referring now to FIG. 3, the information contained in that local database 44, or linked to the program 32 from databases 18, may be provided to the data exchange module 42 and presented as a webpage 53 to the patient, the webpage 53 providing a unified view of the patient's health information from the multiple sources of the healthcare providers 12 and 14, third party PHR sites 29 and transport container 24. Significantly the information may be divided into categories 52 that span the sources, for example, relating to messages, appointment information, recommended preventative care and laboratory tests. Information of the categories may be visually aggregated (sorted and collected) by datatype, for example, to be displayed on the same webpage or screen or in proximity to other data of similar data types.

Each category 52, is identified as to the healthcare provider 12 to which it is related by an icon block 54 depicting a trademark, logo or other symbol or text element identifying the healthcare provider 12, and visually linked thereto, for example, by proximity or a common frame or other visual device. This icon block 54 eliminates confusion as to the source of the healthcare information that would normally be available from context from the individual websites but where the context is lost by the aggregation of the present invention. Significantly, too, the icon block 54 enhances the visibility of the healthcare provider in the process of collecting and providing healthcare information preserving the incentive for the healthcare provider to provide high quality service in this area and encouraging the healthcare provider to permit this aggregation of information from their proprietary data banks.

The icon blocks 54 may provide hyperlinks to the health data portals of the institutions 12 and 14 to preserve a connection with the institution and to incentivize the institutions 12 and 14 in the creation of effective and helpful portal sites. In addition, separate hyperlinks 55 may be provided for the same purpose.

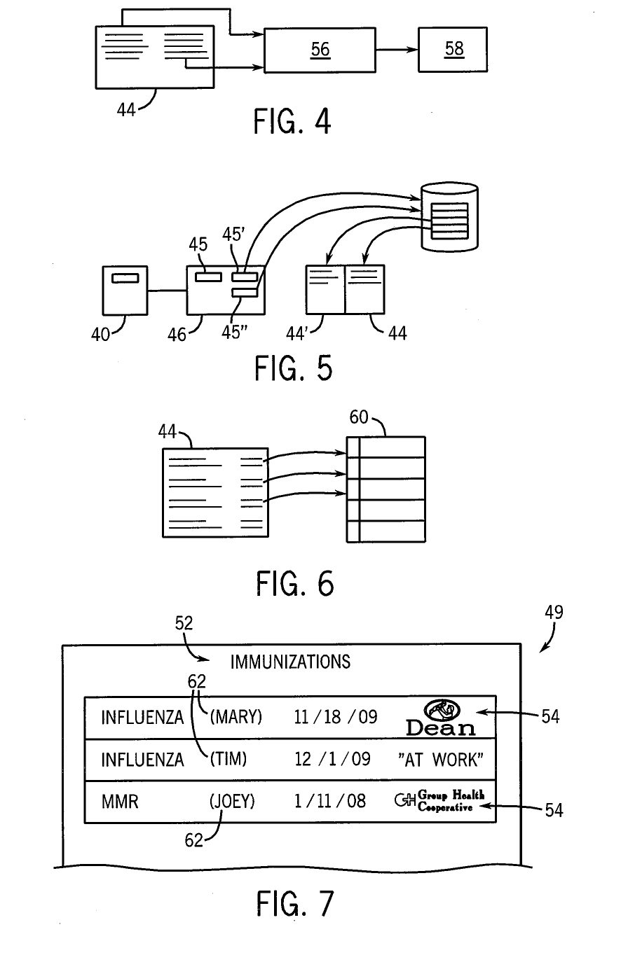

Referring now to FIG. 4, the aggregator 26, by collecting data from disparate sources, provides a unique perspective on the patient's data that may not be available to any individual healthcare provider 12. In this regard the aggregator 26 may run a background agent program 56 that reviews the local database 44 (or linked information) according to a set of interaction rules to identify possible conflicts or duplications in the information or additional information that can be derived from this more global scope. In the event a conflict is found (for example inconsistent data) or the patient may need to be alerted based on the more complete information set available to the aggregator 26, the program 56 may provide an alert 58 to the patient, for example, in the form of a pop-up window. The rules of the interaction program 56 may include basic data error rules, for example, comparing gender or age and other identifying information of the patient to ensure that the correct medical data has in fact been obtained in the unlikely event that a login error occurred. Data of different data types may be compared by means of simple contextual understandings, for example looking for data entries that are inappropriate for the data indicated gender of the patient. Conflicting data of the identical data type from two patients, for example indicating different allergies, may also be flagged. Conflicting data related to identical data elements derived from multiple sources may also be flagged. More sophisticated rules may look for possible drug interactions between medications related to different healthcare providers or check for routine immunizations. The alerts 58 may allow the patient to address errors and/or fill in the gaps in his or her healthcare record ensuring it is more complete. Knowledge that the data of the aggregator 26 should be complete allows the alerts to suggest basic data that should be in the patient's healthcare record.

Generally the inconsistencies can fall into the following categories:

1. Important healthcare data is missing from the records of one institution (e.g. no indicated penicillin allergy)

2. Healthcare information from two institutions is inconsistent (e.g. records indicate different severity of penicillin allergy)

3. Healthcare data is consistent but needs reconciling (1 pcn allergy and 1 penicillin allergy, coded differently)

4. Healthcare data is consistent and needs consolidation (2 identical entries of penicillin allergies) and

5. Different healthcare data is inconsistent in the context of a given patient e.g. penicillin allergy and penicillin on a medication list)

Referring now to FIG. 5, the present invention may also serve to aggregate patient records among different individuals at one or more healthcare providers 12, for example aggregating patient records and/or other patient information for a parent and his or her children. In this regard, the login module 40 may allow passwords to be gathered for multiple family members, for example, including different passwords 45, 45′, and 45″ associated with different individuals. Alternatively, if the healthcare provider 12 manages and governs this proxy relationship, this information may be communicated with 40, thereby eliminating the need for passwords 45, 45′, and 45″, for as long as the relationship is valid as determined by the healthcare provider 12. In this case multiple login sessions to remote databases 18 may be performed and multiple local databases 44 and 44′ may be generated. The information on these databases may be presented in single unified form in some categories 52 (for example appointment schedules) or held separately as context would require. Again the benefit of a single collection of information with multiple healthcare providers and organizations is obtained. Appointment data may be culled from the health data portal sites or may be captured by creating a common appointment interface for the multiple institutions working through the aggregator 26.

Referring now to FIG. 6, the ability to collect all healthcare information for a given patient or family in a single source facilitates personal accounting for healthcare expenditures. Accordingly, the present invention may incorporate money-management features, for example similar to those provided by money-management software such as Quicken or Microsoft Money, to allow an electronic ledger 60 to be linked to elements of the local database 44. This linkage may be accomplished by an internal connection with the money management software executed in the aggregator 26 and served as an application to the patient or by creating an exportable file that may be imported by the money management system held on the home terminal 10.

In this system, appointments that are scheduled or otherwise processed by the aggregator 26 may trigger an accounting entry blank in this electronic ledger 60 and a reminder that the cost for this particular procedure should be recorded by the patient. The patient may also independently add information to the electronic ledger 60 on his or her own initiative, for example, after the purchase of medical supplies that are not subject to prescription. The money-management software can thus provide a full tax accounting to the patient that may be cross-checked against the actual patient records of the patient for improved reliability and completeness.

Referring now to FIG. 7, the present invention may generate a display 49 in which clinical medical data, in this case immunizations, can be aggregated by the data type (e.g. immunization types and/or date) for multiple patients within a family using the proxy mechanism described above. The integration by datatype still allows each family member to be separately indicated by monikers 62 that may be chosen by the patient. As before, the institutions at which the records are held (and imported) may be indicated by icon blocks 54 being a logo and/or text of the institution or, if the record is sourced by the patient, a source of the medical service may be entered by the patient, for example, for an immunization taking place through work or the like.

The present invention addresses the goal of having complete medical information available to the patient that may be portable and provided, for example, to healthcare professionals in an emergency situation anywhere in the world without the reliance on the creation of a single uniform body for the storage and dissemination of healthcare records. By working with multiple healthcare providers, possibly each with proprietary formats, including those where context information is not necessarily recorded, the present invention provides an important step toward the goal of a single, lifetime, medical record that is readily accessed by an individual while accommodating the benefits in innovation and flexibility of a pluralistic healthcare system.

It is specifically intended that the present invention not be limited to the embodiments and illustrations contained herein and the claims should be understood to include modified forms of those embodiments including portions of the embodiments and combinations of elements of different embodiments as come within the scope of the following claims.

We claim:

1. A health data portal aggregator comprising:
at least one electronic computer electronically connected to a computer network communicating with at least two health data portals of the type providing access by a patient to clinical records of the patient from electronic medical record systems associated with corresponding healthcare institutions, the electronic computer executing a stored program to:
(a) receive authentication information from a patient;
(b) use the authentication information together with stored access information for the health data portals to collect clinical records from the electronic medical record systems of the healthcare institutions over the computer network, the clinical records providing clinical medical data having datatypes;
(c) display the clinical medical data visually aggregated by datatypes; and
(d) visually associate the visually aggregated clinical medical data with information identifying the healthcare institutions sourcing the clinical medical data.

2. The health data portal aggregator of claim 1 wherein the information identifying the healthcare institution is a logo for the healthcare institution.

3. The health data portal aggregator of claim 1 wherein the electronic computer further executes the stored program to:
(e) display hyperlinks to the health data portals in conjunction with the display of the clinical medical data.

4. The health data portal aggregator of claim 3 wherein the information identifying the health care institutions are hyperlinks to the health data portals of the health care institutions.

5. The health data portal aggregator of claim 1 wherein the electronic computer further executes the stored program to receive patient-sourced data from the patient and to display the same to the patient.

6. The health data portal aggregator of claim 5 wherein the patient-sourced data includes financial data related to medical treatment.

7. The health data portal aggregator of claim 1 wherein the stored program identifies the datatypes of the clinical data by XML tags.

8. The health data portal aggregator of claim 1 wherein the stored program reviews the collected clinical records for conflicts among records.

9. The health data portal aggregator of claim 8 wherein the conflicts are selected from the group consisting of: missing, duplicate, contradictory, and inconsistent data.

10. The health data portal aggregator of claim 1 wherein the stored program reviews the collected clinical records to make recommendations to the patient.

11. The health data portal aggregator of claim 1 wherein the stored program further uses the authentication information to collect clinical records from the electronic medical record systems of the healthcare institutions for multiple patients related to the patient and
wherein the display of the clinical medical data further identifies each clinical medical data with a name of a patient of the multiple patients.

12. The health data portal aggregator of claim 1 wherein the stored program further uses the authentication information to collect appointment data related to appointments at the corresponding healthcare institutions and wherein the appointment data is visually aggregated by an appointment time and visually associated with information identifying the healthcare institutions related to the appointments.

13. The health data portal aggregator of claim 12 wherein the appointment data is collected by a common interface provided by the stored program through which appointments may be made, and using the common interface to collect appointment data while the appointment is being made.

14. The health data portal aggregator of claim 1 wherein the computer network is the Internet and the healthcare portals are webpages.

15. A computerized aggregator for personal medical information comprising:
(a) an electronic memory holding:
(i) healthcare institution data related to multiple healthcare providers who provide patient accessible Web portals for personal medical information;
(ii) credentialing data for the patient accessible Web portals, the credentialing data allowing access by a given patient;
(b) an electronic computer connected to the Internet and executing a stored program to:
(i) connect to each of the patient-accessible portals identified in the electronic storage medium;
(ii) extract healthcare information for the given patient from each of the portals with datatype identifying information;
(iii) generate a Web-accessible report blending the healthcare information of different healthcare providers according to the datatype identifying information; and
(iv) link the healthcare information to a trademark of the healthcare provider.
